(19) United States
(12) Patent Application Publication
(10) Pub. No.: US 2023/0284617 A1
(43) Pub. Date: Sep. 14, 2023

(54) AGROCHECMIAL COMBINATIONS

(71) Applicant: UPL Limited, Mumbai (IN)

(72) Inventors: Pradip Dattatray Wagh, Mumbai (IN); Narayanasamy Ramanathan Rajapandian, Mumbai (IN)

(21) Appl. No.: 18/005,715

(22) PCT Filed: Jul. 23, 2021
(86) PCT No.: PCT/IB2021/056662

§ 371 Date: Jan. 17, 2023

(30) Foreign Application Priority Data
Jul. 24, 2020 (IN) 202021031812

(51) Int. Cl. A01N 43/54; A01N 43/52; A01N 43/88; A01P 7/04; A01P 3/00

(52) U.S. Cl. CPC A01N 43/54; A01N 43/52; A01N 43/88; A01P 7/04; A01P 3/00

(57) ABSTRACT

A plant propagation material treatment combination contains azoxystrobin; at least one benzimidazole fungicide; and at least one neonicotinoid insecticide, wherein the combination does not contain fipronil. The combination or a composition containing the combination can be applied to a plant propagation material before sowing to improve vigour or yield of a plant or to control soil borne fungi and insect pests.

### FIELD

The present disclosure relates to agrochemical combinations for the control of plant pests. More particularly, the present disclosure relates to novel combinations, compositions comprising these combinations and methods of using the combinations and compositions for the treatment of plant propagation materials.

### BACKGROUND

Combinations of insecticides and fungicides are often used to broaden the spectrum of control of insect and fungal pests, and to reduce dosage, thereby reducing environmental impact, and decreasing the chances of developing resistance. The combination of insecticides and fungicides at times demonstrates an additive or synergistic effect that results in an improved control of the pests.

Damage to seeds from insect and fungal pests is a major concern for the agriculturalist. There are various diseases such as seed rot which reduce germination rates and cause considerable decrease in yield. Treating the seeds with insecticides and/or fungicides can help reduce damage caused by soil pests. Additional potential advantages of treating seeds or other plant propagation materials are improvements in germination rates, increased yield, and improved plant health.

There are many combinations of insecticides and fungicides known in the art for the control of soil borne pests. U.S. Pat. No. 7,732,374B2 teaches a combination of prothioconazole and a specific insecticide selected from fipronil, chlorpyrifos or thiamethoxam for the control of pests in seeds, soils, and the like.

Using the same compositions over a long period of time can result in resistance to certain pests. There is thus a need in the art for novel combinations of actives that decrease the chances of resistance and improve the spectrum of disease and pest control.

### OBJECTIVES

One objective of the present disclosure is to provide improved combinations of insecticides and fungicides for the control of soil borne pests.

Another objective of the present disclosure is to provide a method and a composition for controlling insect pests and fungal diseases by treating plant propagation material.

Yet another objective of the present disclosure is to provide improved combinations of insecticides and fungicides that promote plant health.

Embodiments of the present disclosure can ameliorate one or more of the above mentioned problems.

### SUMMARY

In an aspect, the present disclosure provides a combination of azoxystrobin; at least one benzimidazole fungicide; and at least one neonicotinoid insecticide; wherein the combination does not contain fipronil.

Another aspect of the present disclosure provides a method of improving yield in crops, the method comprising applying to a plant propagation material of a crop, a combination comprising azoxystrobin; at least one benzimidazole fungicide; and at least one neonicotinoid insecticide; wherein the combination does not contain fipronil.

Yet another aspect of the present disclosure provides a method of improving plant health, the method comprising applying to a plant propagation material of a crop a combination comprising azoxystrobin; at least one benzimidazole fungicide; and at least one neonicotinoid insecticide; wherein the combination does not contain fipronil.

Another aspect of the present disclosure provides a composition for treating a plant propagation material, the composition comprising azoxystrobin; at least one benzimidazole fungicide; at least one neonicotinoid insecticide; and an agrochemical adjuvant; wherein the composition does not contain fipronil.

In another aspect, the present disclosure provides a method of controlling pests by treating a plant propagation material with a composition comprising azoxystrobin; at least one benzimidazole fungicide; at least one neonicotinoid insecticide; and an agrochemical adjuvant; wherein the composition does not contain fipronil.

In yet another aspect, the present disclosure provides a method for improving plant health, the method comprising applying to a plant propagation material of a crop plant a combination comprising azoxystrobin; at least one benzimidazole fungicide; at least one neonicotinoid insecticide; and an agrochemical adjuvant; wherein the composition does not contain fipronil.

### DETAILED DESCRIPTION OF THE DISCLOSURE

The term “plant propagation material” refers to the parts of the plant, such as seeds, which can be used for the propagation of the plant and vegetative plant materials such as cuttings and tubers (for example, potatoes). Plant propagation materials include the seeds (in the strict sense), roots, fruits, tubers, bulbs, rhizomes, and other parts of plants, germinated plants or young plants, which may be transplanted after germination or after emergence from the soil.

“Insecticidal” refers to the ability of a substance to increase mortality or inhibit, growth rate of insects. “Fungicidal” refers to the ability of a substance to decrease or inhibit growth of fungi. The term “agriculturally acceptable amount of active” refers to an amount of an active, for example, an insecticide or a fungicide that kills or inhibits the plant disease for which control is desired, in an amount not significantly toxic to the plant being treated. To “control” or “controlling” insects means to inhibit, through a toxic effect, the ability of insect pests to survive, grow, feed, and/or reproduce, or to limit insect-related damage or loss in crop plants, or denotes control and prevention of a disease caused by insect pests. Controlling effects of insect pests include all deviation from natural development, for example killing, retardation, decrease of the fungal disease or insect pest. To “control” insects may include killing the insects, and preferably means killing the insects.

The term “improved seed vigour” refers to seed properties that determine potential for fast and uniform emergence, and the development of seedlings under a wide range of field conditions, when compared with the same trait in a control plant which has been grown under the same conditions in the absence of the method of the disclosure. Such traits may include, early and/or improved germination, improved emergence, increased root growth, a developed root system, increased root nodulation, increased shoot growth, improvement in plant height, an increase in plant weight (fresh or dry), bigger leaf blades, greener leaf colour, increased pigment content, increased photosynthetic activity, earlier flowering, longer panicles, early grain maturity, increased seed, fruit or pod size, increased pod or ear number, increased seed number per pod or ear, increased seed mass, enhanced seed filling, delay of senescence, and improved vitality of the plant.

The present inventors found unexpected synergy when azoxystrobin is combined with a benzimidazole fungicide and a neonicotinoid insecticide, wherein the combination does not contain fipronil. More specifically, the present inventors found unexpected synergy when azoxystrobin is combined with either carbendazim or thiophanate methyl and at least one neonicotinoid insecticide, wherein the combination does not contain fipronil.

Azoxystrobin is a systemic fungicide belonging to the strobilurin class of compounds. Its mode of action is attaching to the Qo site of complex III of the mitochondrial electron transport chain, thereby preventing the production of ATP. Its chemical name is methyl (E)-2-{2-[6-(2-cyanophenoxy) pyrimidin-4-yloxy]phenyl}-3-methoxyacrylate. Complex III of the electron transport chain is also known as Q-cytochrome c oxidoreductase or simply cytochrome reductase.

Benzimidazole fungicides inhibit mitosis and cell division in fungi. They are broad spectrum fungicides and can control a wide variety of fungi.

Neonicotinoid insecticides areacetylcholine receptor (nAChR) agonists. These insecticides can control a broad spectrum of insect pests.

The present inventors have shown that the combinations of the present disclosure surprisingly result in a synergistic action. The combinations of the present disclosure allow for a broad spectrum of pest control and provide surprisingly improved plant vigour and yield. The broad spectrum of action the present combinations also provide a solution for preventing the development of resistance.

Therefore, an aspect of the present disclosure provides combinations comprising:
ii) azoxystrobin;
ii) at least one benzimidazole fungicide; and
iii) at least one neonicotinoid insecticide;
   wherein the combinations do not contain fipronil.

The benzimidazole fungicide can comprise albendazole, benomyl, carbendazim, chlorfenazole, cypendazole, debacarb, fuberidazole, mecarbinzid, rabenzazole, thiabendazole, furophanate, thiophanate, thiophanate-methyl, or a combination thereof.

In an embodiment, the benzimidazole fungicide comprises benomyl, carbendazim, thiophanate or thiophanate-methyl, or a combination thereof.

In an embodiment, the benzimidazole fungicide is thiophanate methyl.

The neonicotinoid insecticide may comprise acetamiprid, clothianidin, imidacloprid, nitenpyram, nithiazine, thiacloprid, thiamethoxam, or a combination thereof.

In a preferred embodiment, the neonicotinoid insecticide comprises acetamiprid, thiamethoxam, imidacloprid, or a combination thereof.

In a preferred embodiment, the neonicotinoid insecticide is thiamethoxam.

Thus, an embodiment of the present disclosure provides combinations for treatment of a plant propagation material comprising:
i) azoxystrobin;
ii) at least one benzimidazole fungicide selected from carbendazim, thiophanate-methyl, and combinations thereof; and
iii) at least one neonicotinoid insecticide selected from imidacloprid, acetamiprid, thiamethoxam, and a combination thereof;
   wherein the combinations do not contain fipronil.

Another embodiment of the present disclosure provides combinations for treatment of a plant propagation material comprising:
i) azoxystrobin;
ii) at least one benzimidazole fungicide selected from carbendazim, thiophanate methyl, and a combination thereof; and
iii) thiamethoxam;
   wherein the combinations do not contain fipronil.

The fungicides and insecticide of the combination of the present disclosure may be present in a weight ratio of (1-80):(1-80):(1-80) of the azoxystrobin, the benzimidazole fungicide, and the neonicotinoid insecticide respectively. The azoxystrobin, the benzimidazole fungicide, and the neonicotinoid insecticide can be present in the combinations in a weight ratio of 1:(1-15):(5-30), preferably in a weight ratio of 1:(1-11):(4-10), and more preferably in a weight ratio of 1:(3-11):(4-6).

The combinations of the present disclosure may be admixed with suitable agrochemical adjuvants to form compositions.

Thus, an aspect of the present disclosure provides a composition comprising:
i) azoxystrobin;
ii) at least one benzimidazole fungicide selected from carbendazim, thiophanate methyl, and a combination thereof;
iii) at least one neonicotinoid insecticide; and
iv) an agrochemcially acceptable adjuvant;
   wherein the composition does not contain fipronil.

Another aspect of the present disclosure provides a composition comprising:
i) azoxystrobin;
ii) thiophanate methyl;
iii) at least one neonicotinoid insecticide; and
iv) an agrochemically acceptable adjuvant;
   wherein the composition does not contain fipronil.

Another aspect of the present disclosure may provide a composition comprising:
i) azoxystrobin;
ii) thiophanate methyl;
iii) thiamethoxam; and
iv) an agrochemically acceptable adjuvant;
   wherein the composition does not contain fipronil.

Another aspect of the present disclosure provides a composition consisting essentially of:
i) azoxystrobin;
ii) thiophanate methyl;
iii) thiamethoxam; and
iv) an agrochemically acceptable adjuvants.

Another aspect of the present disclosure provides a composition consisting:
i) azoxystrobin;
ii) thiophanate methyl;
iii) thiamethoxam; and
iv) an agrochemically acceptable adjuvants.

The total amount of azoxystrobin in the compositions is in the range of 0.1 to 99% by weight. The total amount of the benzimidazole fungicide(s) in the compositions is in the range of 0.1 to 99% by weight. The total amount of the neonicotinoid insecticide(s) in the compositions is in the range of 0.1 to 99% by weight. As used herein, % by weight is based on the total weight of the treatment compositions.

In one preferred embodiment, the total amount of azoxystrobin in the compositions is in the range of 0.1 to 5%, preferably 2 to 5% by weight of the composition. The total amount of benzimidazole fungicide the compositions is in the range of 10 to 20%, preferably 10 to 15% by weight of the composition. The total amount of neonicotinoid insecticide in the compositions is in the range of 15 to 30% preferably 20 to 30% by weight of the composition.

In one preferred embodiment, the total amount of azoxystrobin in the compositions is in the range of 0.1 to 5%, preferably 2 to 5% by weight of the composition. The total amount of thiophanate methyl in the compositions is in the range of 10 to 20%, preferably 10 to 15% by weight of the composition. The total amount of thiamethoxam in the compositions is in the range of 15 to 30% preferably 20 to 30% by weight of the composition.

In an embodiment, the compositions of the present disclosure may be applied as per known methods of application to seeds or other plant propagation material or transplanted saplings.

In an embodiment, the plant propagation material is a seed.

The composition of present disclosure used for seed treatment is efficacious in protecting the seed and/or the plant against injury caused by target insects during the target insects' life cycle. In general, the present compositions are efficacious for about 0 to 120 days after sowing of seeds, at the same time preventing unacceptable phytotoxicity.

Thus, in an embodiment, the present disclosure provides a seed treated with the present compositions.

In another embodiment, the present disclosure provides a plant material treated with the present compositions, such that at least a portion of the applied compositions is adhered to the plant material.

In another embodiment, the present disclosure provides a seed treated with the present compositions, such that at least a portion of the applied compositions is adhered to the seed.

In an embodiment, the seed is selected from soybean seed, orange seed, raspberries seed, broccoli seed, prune seed, corn seed, peach seed, mango seed, celery seed, conifer seed, tangerine seed, kiwi fruit seed, gooseberry seed, plum seed, pumpkin seed, beet seed, star fruit seed, bean seed, carrot seed, asparagus seed, apple seed, crab apple seed, and swiss chard seed.

In an embodiment of the present disclosure, the compositions can be formulated into either solid or liquid formulations that are suitable for application to plant propagation material. The formulations may be made in known formulation types such as wet table powders (WP), solutions (LS), emulsions (ES), suspension concentrates (FS), water dispersible granules (WG), and aqueous suspension concentrates (CS).

In another embodiment, the present compositions used to coat a seed or plant or plant propagation material is in the form of a flowable concentrate, a suspension concentrate, an emulsifiable concentrate or any other suitable liquid formulation that can coat the seed or plant or plant propagation material.

In a preferred embodiment, the formulation is a flowable concentrate (FS).

In an embodiment, FS formulation of present compositions is used for seed treatment of soybean.

In an embodiment of each aspect, application rate of a FS formulation is from 0.1 to 1000 ml/10 kg seed, particularly on a soybean seed.

Typically, the plots are treated with present compositions at application rate of 50 ml/10 kg to 200 ml/10 kg, preferably in the range of 50 to 150 ml/10 kg of plant propagation 1.5 materials such as seeds.

In one preferred embodiment, the treatment is provided with present compositions at application rate of 100 ml/10 kg of seed to 130 ml/10 kg of plant propagation materials such as seeds.

The combinations and compositions can also comprise or may be applied together and/or sequentially with further active compounds. These further compounds can be selected from fertilizers or micronutrient donors or microorganisms or other preparations that influence plant growth, such as inoculants (e.g. a strain of nitrogen-fixing bacteria), and plant inducers.

The formulation may be applied by various methods using conventional treating techniques and machines, such as fluidized bed techniques, the roller mill method, rotostatic seed treaters, drum coaters, drones, and spouted beds. Pre- and post-coating procedures such as sizing may also be carried out. Such procedures are known in the art.

In an embodiment, the treatment may occur before sowing of the plant propagation material so that the sown material has been pre-treated with the combination. In particular, seed coating or seed pelleting are preferred in the treatment of the combinations according to the disclosure. As a result of the treatment, the active ingredients in the combination adhere to the seed and therefore available for pest and/or disease control.

The formulations may contain at least one of agriculturally acceptable adjuvants, carriers, diluents, emulsifiers, fillers, anti-foaming agents, thickening agents, anti freezing agents, biocides, or pigments.

Suitable agricultural adjuvants and carriers include, but are not limited to, crop oil concentrates; methylated seed oils; emulsified methylated seed oils; nonylphenol ethoxylate; benzylcocoalkyldimethyl quaternary ammonium salt; blend of petroleum hydrocarbon, alkyl esters, organic acid, and anionic surfactant; C9-C11 alkylpolyglycoside; phosphated alcohol ethoxylate; natural primary alcohol (C12-C16) ethoxylate; di-sec-butylphenol EO-PO block copolymer; polysiloxane-methyl cap; nonylphenol ethoxylate, urea ammonium nitrate; tridecyl alcohol (synthetic) ethoxylate (8E0); tallow amine ethoxylate; PEG(400) dioleate-99, alkyl sulfates, such as diethanolammonium lauryl sulfate; alkylarylsulfonate salts, such as calcium dodecylbenzenesulfonate; alkylphenol-alkylene oxide addition products, such as nonylphenol-Cis ethoxylate; alcohol-alkylene oxide addition products, such as tridecyl alcohol-C₁₆ ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

Exemplary liquid carriers that may be employed in a composition of the present disclosure include water and organic solvents. The organic solvents include, but are not limited to, petroleum fractions or hydrocarbons such as mineral oil, aromatic solvents, and paraffinic oils; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, and tung oil; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, and di-octyl phthalate; or esters of mono, di and polycarboxylic acids. Organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, and dimethyl sulfoxide.

Solid carriers that may be employed in the compositions of the present invention may include, but are not limited to, attapulgite, pyrophyllite clay, silica, kaolin clay, kieselguhr, chalk, diatomaceous earth, lime, calcium carbonate, bentonite clay, Fuller's earth, talc, cottonseed hulls, wheat flour, soybean flour, pumice, wood flour, walnut shell flour, lignin, and cellulose.

Thickeners that may be employed in the compositions of the present disclosure include but are not limited to silicates such metal silicates, sodium carboxymethyl cellulose, methyl cellulose, ethyl cellulose, polyvinylalcohol, sodium alginate, sodium poly acrylate, xanthan gum, welan gum, gum arabic, montmorillonite, lignosulfonates, hydroxy methyl cellulose, dextrin, starch, and combinations thereof.

Anti-freezing agents that may be employed in the compositions of the present disclosure include but are not limited to glycerin, ethylene glycol, andpropylene glycol, preferably propylene glycol.

Anti-foaming agents that may be employed in the compositions of the present disclosure include but are not limited to silicone oils, or mineral oils, Fatty acid ester; biocides such as sodium benzoate, 1,2-benzisothiazoline-3-one, 2-methyl-4-isothiazolin-3-one, 5-chloro-2-methyl-4-isothiazolin-3-one, potassium sorbate, and parahydroxy benzoates.

Pigments that may be employed in the compositions of the present disclosure may include but are not limited to pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, violet 23, acid red 51, acid red 52, acid red 14, acid blue 9, acid yellow 23, basic red 10, and basic red 108.

Polymers that may be employed in the compositions of the present disclosure include but are not limited to polyvinyl alcohols, polyvinylpyrrolidone, gel-forming carraagheenans, water-soluble gelatine and casein, superabsorbent polymers such polyacrylamides and polyacrylates based polymers, semi-synthetic or fully-synthetic peptide/protein-based superabsorbent polymers such as collagen-based synthetic polymers, elastin-like polypeptides, polyaspartic acid, polyaspartates, polyglutamic acid, polyglutamate, Semi-synthetic or fully-synthetic polysaccharide: carboxymethyl starch, sulfoethyl starch, carboxymethyl cellulose, sulfoethyl cellulos, hydroxypropyl cellulose, hydroxyethyl cellulose, methylcellulose, chitosan; cross-linked polysaccharides such as CMS cross-linked with multi-functional carboxylic acids or multi-functional epoxides, polysaccharides obtained by graft polymerizing a monomer onto a polysaccharide, wherein the monomer is selected from acrylonitrile, acrylic acid, methacrylic acid, acrylamide, methacrylamide, 2-acrylamido-2-methyl-propanesulfonic acid (AMPS), vinyl sulfonic acid, ethyl acrylate, and potassium acrylate.

The combinations and the treatment compositions of the present disclosure are effective against phytopathogenic fungi, especially those occurring in plants, including seed borne fungi. Exemplary fungi belong to the following classes: Ascomycetes (e.g. Penicillium, Gaeumannomyces graminis); Basidiomycetes (e.g. the genus Hemileia, Rhizoctonia, Puccinia); Fungi imperfecti (e. g. Botrytis, Helminthosporium, Rhynchosporium, Fusarium, Septoria, Cercospora, Alternaria, Pyricularia and Pseudocercosporella herpotrichoides); Oomycetes (e. g. Phytophthora, Peronospora, Bremia, Pythium, Plasmopara); and Zygomycetes (e.g., Rhizopus spp.).

The combinations and the treatment compositions of the present disclosure are especially effective against Alternaria spp., Ascochyta spp., Aspergillus spp., Claviceps purpurea, Cochliobolus spp., Colletotrichum spp., Diplodia maydis, Erysiphe graminis, Fusarium spp. (such as Fusarium culmorum, Fusarium oxysporum, Fusarium solani, Fusarium graminearum, Fusarium moniliforme, Fusarium subglutinans), Gaeumannomyces graminis, Giberella fujikuroi, Giberella zeae, Helminthosporium spp. (such as Helminthosporium graminearum, Helminthosporium oryzae, Helminthosporium solani), Monographella nivalis, Penicillium spp., Puccinia spp., Pyrenophora spp. (such as Pyrenophora graminea), Peronosclerospora spp., Peronspora spp., Phakopsora pachyrhizi, Phythium spp., Phoma spp., Phomopsis spp., Rhizoctonia spp. (such as Rhizoctonia cerealis, Rhizoctonia solani), Septoria spp., Pseudocercosporella spp., Tilletia spp., Rhizopus spp., Thielaviopsis basicola, Typhula spp., Ustilago spp., Sphacelotheca spp. (e.g. Spacelotheca reilliani), Thanatephorus cucumeris, and Verticillium spp.

The present combinations and treatment compositions may be used to control insect pests such as those from the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia spp., Cryptophlebia leucotreta, Crysodeixis includens, Cydia spp., Diatraea spp., Diparopsis castanea, Earias spp., Elasmopalpus spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Coleoptera, for example, Agriotes spp., Anthonomus spp., Atomaria linearis, Ceutorhynchus spp., Chaetocnema tibialis, Cosmopolites spp., Curculio spp., Dermestes spp., Diabrotica spp., Epilachna spp., Eremnus spp., Gonocephalum spp., Heteronychus spp., Leptinotarsa decemlineata, Lissorhoptrus spp., Melolontha spp., Orycaephilus spp., Otiorhynchus spp., Phlyctinus spp., Phyllotreta spp., Popillia spp., Protostrophus spp., Psylliodes spp., Rhizopertha spp., Scarabeidae, Sitophilus spp., Sitotroga spp., Tenebrio spp., Tribolium spp. and Trogoderma spp.; from the order Orthoptera, for example, Blatta spp., Blattella spp., Gryllotalpa spp., Leucophaea maderae, Locusta spp., Periplaneta spp. and Schistocerca spp.; from the order Isoptera, for example, Reticulitermes spp.; from the order Psocoptera, for example, ijposcelis spp.; from the order Anoplura, for example, Haematopinus spp., Linognathus spp., Pediculus spp., Pemphigus spp. and Phylloxera spp.; from the order Mallophaga, for example, Damalinea spp. and Trichodectes spp.; from the order Thysanoptera, for example, Frankliniella spp., Hercinothrips spp., Taeniothrips spp; Thrips palmi, Thrips tabaci and Scirtothrips aurantii; from the order Heteroptera, for example, Dichelops melacanthus, Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; from the order Homoptera, for example, Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp. Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; from the order Hymenoptera, for example, Acromyrmex, Athalia rosae, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; from the order Diptera, for example, Antherigona soccata, Bibio hortulanus, Ceratitis spp., Chrysomyia spp., Culex spp., Cuterebra spp., Dacus spp., Delia spp., Drosophila melanogaster, Liriomyza spp. Melanagromyza spp., Orseolia spp., Oscinella frit, Pegomyia hyoscyami, Phorbia spp., Rhagoletis pomonella, Sciara spp., from the order Acarina, for example, Acarus siro, Aceria sheldoni, Aculus schlechtendali, Amblyomma spp., Argas spp., Brevipalpus spp., Bryobia praetiosa, Calipitrimerus spp., Chorioptes spp., Dermanyssus gallinae, Eotetranychus carpini, Eriophyes spp., Hyalomma spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; and from the class Nematoda, for example, the species of Meloidogyne spp. (for example, Meloidogyne incoginita and Meloidogyne javanica), Heterodera spp. (for example, Heterodera glycines, Heterodera schachtii, Heterodora avenae and Heterodora trifolii), Globodera spp. (for example, Globodera rostochiensis), Radopholus spp. (for example, Radopholus similes), Rotylenchulus spp., Pratylenchus spp. (for example, Pratylenchus neglectans and Pratylenchus penetrans), Aphelenchoides spp., Helicotylenchus spp., Hoplolaimus spp., Paratrichodorus spp., Longidorus spp., Nacobbus spp., Subanguina spp. Belonlaimus spp., Criconemella spp., Criconemoides spp. Ditylenchus spp., Dolichodorus spp., Hemicriconemoides spp., Hemicycliophora spp., Hirschmaniella spp., Hypsoperine spp., Macroposthonia spp., Melinius spp., Punctodera spp., Quinisulcius spp., Scutellonema spp., Xiphinema spp., and Tylenchorhynchus spp.

In an embodiment, the insect pest may be from Lepidopteran, Coleopteran, Hemipteran, or Homopteran species. However, the choice of the target insect pests is not limiting.

In an embodiment, Lepidopteran pest species which negatively impact agriculture and are controlled by the combinations and treatment compositions of the present disclosure include, but are not limited to, Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp.(noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

In yet another embodiment, the insect pests that are controlled by the combinations and the treatment compositions of the present disclosure are of the order Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), Chistocerca gregaria, Scudderia furcata (forktailed bush katydid) and Valanga nigricorni.

In yet another embodiment, the insect pests that are controlled by the combinations and the treatment compositions of the present disclosure are of the order Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp. In an embodiment Coleopteran insect pests that are controlled by the combinations and treatment compositions of the present disclosure may be selected from but not limited to Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus as Similis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In an embodiment, the insect pests that are controlled by the combinations and treatment compositions of the present disclosure are of the order Hemiptera, such as Acrosternum hilare (green stink bug), Blissus leucopterus (chinch bug), Calocoris norvegicus (potato mind), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

In an embodiment, the insect pests that are controlled by the combinations and treatment compositions of present disclosure are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweet potato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red bawax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape Phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana. In an embodiment, the combinations and compositions of the present disclosure may be used for treatment of plant propagation material of crops such as cereals such as wheat, barley, rye, oats, corn, rice, sorghum, triticale and related crops; beets such as sugar beet and fodder beet; leguminous plants such as beans, lentils, peas, soybean; oil plants such as rape, mustard, sunflowers; cucurbits such as marrows, cucumbers, melons; fibre plants such as cotton, flax, hemp, jute; vegetables such spinach, lettuce, asparagus, cabbages, carrots, onions, tomatoes, potatoes, paprika as well as ornamentals such as flowers, shrubs, broad-leaved trees and evergreens, such as conifers. The plant propagation material may also be used on varieties of plant propagation material such as conventional, hybrid or transgenic plants.

In an embodiment, the combinations and the compositions of the present disclosure may further contain herbicide, fungicides, insecticides, fertilizers, biologicals, other plant growth additives such as mycorrhiza, silicic acid, and plant derived growth promoters.

In an aspect, the present disclosure provides methods of improving vigour or yield of the plant comprising, applying to a plant propagation material before sowing, a combination comprising:
i) azoxystrobin;
iii) at least one benzimidazole fungicide selected from carbendazim or thiophanate methyl, and a combination thereof; and
iii) thiamethoxam;
   wherein the combination does not contain fipronil.

In another aspect, the present disclosure provides methods of controlling soil borne fungi and insect pests, the method comprising, applying to a plant propagation material before sowing, a combination comprising:
i) azoxystrobin;
ii) at least one benzimidazole fungicide selected from carbendazim or thiophanate methyl, and a combination thereof; and
iii) thiamethoxam;
   wherein the combination does not contain fipronil.

In another aspect, the present disclosure provides methods for treating an unsown seed to protect the seed and/or shoots and foliage of a plant grown from the seed from damage by a pest, the method comprising contacting the unsown seed with a composition comprising azoxystrobin; ii) at least one benzimidazole fungicide selected from carbendazim or thiophanate methyl, and a combination thereof; and iii) thiamethoxam.

In another aspect, the present disclosure provides methods for treating an unsown seed to protect the seed and/or shoots and/or foliage of a plant grown from the seed from damage by a pest, the method comprising contacting the unsown seed with a composition consisting essentially of azoxystrobin; ii) at least one benzimidazole fungicide selected from carbendazim, thiophanate methyl, and a combination thereof; and iii) thiamethoxam.

In an aspect, the combinations or the compositions of the present disclosure may be presented as a kit of parts, or as a ready mix formulation that may be readily applied to the plant propagation material or may be applied to plant propagation material before being commercially vended.

Surprisingly, it has been found by the present inventors that azoxystrobin, a benzimidazole fungicide and thiamethoxam, wherein the combination does not contain fipronil, when applied individually, were ineffective in the control of soil borne fungi and insect pests but demonstrated excellent synergistic control on weeds when applied together. The combination controlled the soil borne fungi and insect pests. The combination of azoxystrobin, a benzimidazole fungicide, preferably thiophanate methyl and thiamethoxam controlled seed borne diseases such as seed rot among others. The current disclosure therefore provides advantageous methods of controlling soil borne fungal and insect pests, preferably on soybean. The present method also provides a broader spectrum of controlling such pests and helps in resistance management, thus improving germination rate and producing plants with improved vigour and a broader spectrum of control at lower use rates.

The combinations and the compositions of the present disclosure exert at least one of the following advantages:

These combinations and the compositions prevent mycelial development, spore germination and the formation of apressories and hautoria, controlling the main soil and seed pathogens such as Rhizoctonia solani and Sclerotinia sclerotiorum. The combinations and the compositions of the disclosure can thus eliminate the fungi present on the surface of the seeds and prevent germination of the spores that come after the treatment, providing a synergistic effect.

The storage time of the thus treated seeds can be greater than 120 days without interfering with the germination and vigor patterns.

The combinations and the compositions of the disclosure can be adapted to a violet color associated with the “optical brightness” providing night time brightness through black light, making it difficult to falsify the product and aiding the differentiation of grain for treated seed.

The combinations and compositions display improvement of the plant defence mechanism against pathogens. They promote the growth of the seedlings through the increment of the root system, with greater depth of roots and better utilization of nutrients. Increased photosynthetic, consequently lower energy consumption of the seedling providing vigorous growth, and conditioning the plant to achieve superior productivity even under stress conditions.

The combinations and the compositions of the disclosure can facilitate better coverage of seeds due to adherence products through a differentiated and specific formulation for the treatment of seeds, consequently less loss of active ingredient.

The plots treated with present combinations or compositions have reduced infestation for insect pests such as shoot fly, termite and white grub.

According to the present disclosure, the treatments achieve high yield and an excellent cost benefit ratio. Further, treatment with present combinations and compositions does not have any adverse effect on the growth of soybean crops or on germination of soybean crops. In addition, the treatments of the present disclosure do not have any harmful effect on the population of natural enemies present in the soybean ecosystem. Nevertheless, the present treatments do not produce any phytotoxicity effect to soybean, and it is safe to use the combinations and compositions in soybean crops for control of seed diseases and insect pests.

However, it should be understood that the scope of the present disclosure is not limited by the examples in any manner. It will be appreciated by any person skilled in this art that the present disclosure includes aforesaid examples and further can be modified and altered within the technical scope of the present disclosure.

While the foregoing written description of the disclosure enables one of ordinary skill to make and use what is considered presently to be the best mode thereof, those of ordinary skill will understand and appreciate the existence of variations, its combinations, and equivalents of the specific embodiment, method, and examples herein. The disclosure should therefore not be limited by the above described embodiment, method, and examples, but by all embodiments and methods within the scope and spirit of the disclosure.

### EXAMPLES

The disclosure will be illustrated with reference to the following examples.

### Example 1

FS Formulation

| | Amount |
|---|---|
| Ingredients | (wt %) |
| Thiamethoxam | 25 |
| (neonicotinoid insecticide) | |
| Thiophanate Methyl | 11.25 |
| (benzimidazole fungicide) | |
| Azoxystrobin Technical | 2.5 |
| Poly-alkylene oxide block | 2.5 |
| copolymer (Atlas ™ G 5000) | |
| Acrylic copolymer solution | 3 |
| (Atlox ™ 4913) | |
| Lignosulphonate (Ufoxane ® 3A) | 0.5 |
| Glycerin | 10 |
| Water | Q.S. |
| Total | 100 |

### Process:

The required quantity of excipients was charged in vessel equipped with a stirrer and a homogenizer. The above-mentioned quantities of active ingredients were charged to the vessel with continuous agitation and homogenization.

Homogenized materials were then feed to the wet grinding mill for particle size reduction (about less than 7 (D-90) micron). The slurry was taken in to the gelling vessel for gelling process till complete gellification to obtain the formulation.

### Example 2

This example illustrates the efficacy of soybean seed treatment with the formulation of example 1. Experiments were carried out to study the bio efficacy of the present compositions as a seed treatment in soybean against soil and seed borne diseases. The results are recorded at 20 and 40 days after sowing (DAS) and are represented in the following tables.

TABLE 1

| | | Crop-Soybean | | | |
|---|---|---|---|---|---|
| | | Seed treatment against root rot and | | | |
| | Dose/ | seedling blight disease | | | |
| | 10 kg | % control at (20 DAS) | | | |
| | of | | | Seedling blight | |
| | seed | Root rot disease | | disease | |
| | (g or | Fusarium | Phytophthora | Rhizoctonia | Pythium |
| Treatments | ml)) | sp. | sp. | sp. | sp. |
| Untreated | — | 0 | 0 | 0 | 0 |
| Formulation | 100 | 65.48 | 79.25 | 65.48 | 67.06 |
| of example 1 | | | | | |
| Formulation | 125 | 71.54 | 79.61 | 71.54 | 67.21 |
| of example 1 | | | | | |
| Azoxystrobin | 12 | 49.90 | 29.98 | 49.87 | 30.92 |
| 23% SC | | | | | |
| Thiophanate | 19.29 | 40.88 | 63.43 | 40.83 | 31.74 |
| methyl 70% | | | | | |
| WP | | | | | |
| Thiamethoxam | 100 | 1.32 | 40.21 | 1.22 | 6.98 |
| 30% FS | | | | | |
| Thiophanate | 25 | 51.29 | 29.98 | 51.22 | 50.63 |
| methyl | | | | | |
| 450 g/l + | | | | | |
| pyraclostrobin | | | | | |
| 50 g/l w/v FS | | | | | |
| Standard | | | | | |

TABLE 2

| | | Crop-Soybean | | | |
|---|---|---|---|---|---|
| | | Seed treatment against root rot and | | | |
| | Dose/ | seedling blight disease | | | |
| | 10 kg | % control at (40 DAS) | | | |
| | of | | | Seedling blight | |
| | seed | Root rot disease | | disease | |
| | (g or | Fusarium | Phytophthora | Rhizoctonia | Pythium |
| Treatments | ml)) | sp. | sp. | sp. | sp. |
| Untreated | — | 0 | 0 | 0 | 0 |
| Formulation | 100 | 58.09 | 69.75 | 60.07 | 55.65 |
| of example 1 | | | | | |
| Formulation | 125 | 62.53 | 69.81 | 60.00 | 64.42 |
| of example 1 | | | | | |
| Azoxystrobin | 12 | 46.00 | 42.65 | 42.25 | 37.99 |
| 23% SC | | | | | |
| Thiophanate | 19.29 | 43.63 | 34.90 | 39.72 | 37.27 |
| methyl 70% | | | | | |
| WP | | | | | |
| Thiamethoxam | 100 | 46.49 | 11.74 | 11.00 | 17.26 |
| 30% FS | | | | | |
| Thiophanate | 25 | 54.68 | 48.29 | 51.60 | 57.81 |
| methyl | | | | | |
| 450 g/l + | | | | | |
| pyraclostrobin | | | | | |
| 50 g/l w/v FS | | | | | |
| Standard | | | | | |

From the above data it is concluded that the present composition as a seed treatment provided good control of root rot and seedling blight diseases as compared to treatments with compositions that do not contain all three of the azoxystrobin, benzimidazole fungicide, and neonicotinoid insecticide of the present compositions.

The present compositions used as a seed treatment was evaluated for efficacy against shoot fly, termite and white grub. Two season trial results indicated that plots treated with the present compositions recorded the least infestation for all three insect pests.

Further, the yield data recorded indicated that present composition treatments provided significantly higher yield as compared to treatments with compositions that comprises one but not all of the azoxystrobin, benzimidazole fungicide, and neonicotinoid insecticide of the present compositions.

The combinations or treatment compositions of the present disclosure also showed synergy after applying Colby's formula.

The present compositions do not have any adverse effect on the growth of soybean crops as or the germination of soybean crops and are safe to use in soybean crops for control of diseases and insect pests.

1. A plant propagation material treatment combination comprising: a) azoxystrobin; b) at least one benzimidazole fungicide; and c) at least one neonicotinoid insecticide; wherein the combination does not contain fipronil.

2. The combination as claimed in claim 1, wherein the benzimidazole fungicide comprises albendazole, benomyl, carbendazim, chlorfenazole, cypendazole, debacarb, fuberidazole, mecarbinzid, rabenzazole, thiabendazole, furophanate, thiophanate, thiophanate-methyl, or a combination thereof.

3. The combination as claimed in claim 1, wherein the neonicotinoid insecticide comprises acetamiprid, clothianidin, nitenpyram, nithiazine, thiacloprid, thiamethoxam, or a combination thereof.

4. The combination as claimed in claim 1, wherein the said combination comprises azoxystrobin, thiophanate methyl and thiamethoxam.

5. The combination as claimed in claim 1, wherein the azoxystrobin, the benzimidazole fungicide, and the neonicotinoid insecticide have a weight ratio of (1-80):(1-80):(1-80).

6. The combination as claimed in claim 1, wherein the azoxystrobin, the benzimidazole fungicide, and the neonicotinoid insecticide have a weight ratio of 1:(1-15):(5-30).

7. A composition comprising the combination of claim 1 and d) an agrochemical adjuvant.

8. The composition as claimed in claim 7, wherein the azoxystrobin is present in an amount of 0.1 to 5% by weight; the benzimdazole fungicide is present in an amount of 10 to 20% by weight; and the neonicotinoid insecticide is present in an amount of 15 to 30% by weight, each based on a total weight of the composition.

9. The composition as claimed in claim 8, where the benzimidazole fungicide comprises albendazole, benomyl, carbendazim, chlorfenazole, cypendazole, debacarb, fuberidazole, mecarbinzid, rabenzazole, thiabendazole, furophanate, thiophanate, thiophanate-methyl, or a combination thereof.

10. The composition as claimed in claim 8, wherein the neonicotinoid insecticide comprises acetamiprid, clothianidin, nitenpyram, nithiazine, thiacloprid, thiamethoxam, or a combination thereof.

11. The composition as claimed in claim 8, wherein the composition comprises: azoxystrobin, thiophanate methyl and thiamethoxam.

12. The composition as claimed in claim 8, wherein the composition comprises 0.1 to 5% by weight of azoxystrobin; 10 to 20% by weight of thiophthanate methyl, and 15 to 30% by weight of thiamethoxam, each based on a total weight of the composition.

13. A method of improving vigour or yield of a plant, the method comprising applying to a plant propagation material before sowing, the combination as claimed in claim 1.

14. A method of controlling soil borne fungi and insect pests, the method comprising applying to a plant propagation material before sowing, the combination as claimed in claim 1.

15. A kit comprising the combination as claimed in claim 1.
